(19) United States
(12) Patent Application Publication
(10) Pub. No.: US 2005/0078783 A1
(43) Pub. Date: Apr. 14, 2005

(54) Digital phase-locked loop circuit

(76) Inventor: Shigeru Okita, Tokyo (JP)

Correspondence Address: TEXAS INSTRUMENTS INCORPORATED, P O BOX 655474, M/S 3999, DALLAS, TX, 75265, US

(21) Appl. No.: 10/933,573

(22) Filed: Sep. 3, 2004

(30) Foreign Application Priority Data
Sep. 5, 2003 (JP) 2003-313,979

(51) Int. Cl. H04L 27/14

(52) U.S. Cl. 375/376

(57) ABSTRACT

The object of the invention is to obtain a stable, locked clock with reduced output jitter in a digital phase-locked loop circuit. Control oscillating part 12 has frequency divider 18, period measurement circuit 20, moving average value computation circuit 22, and output clock generator 24. In intermediate oscillating frequency divider 18, as a result of tracking to synchronization control signals c, d from phase comparator 10, there is a wide variation in the period of intermediate clock g. However, by means of period measurement circuit 20 and moving average value computation circuit 22, varying slowly with a small fluctuation amplitude, period i of the moving average is obtained, and a stable output clock j that tracks reference clock a slowly and reliably is obtained from output clock generator 24.

### FIELD OF THE INVENTION

The present invention pertains to a digital phase-locked loop (DPLL) circuit. More specifically, the present invention pertains to a DPLL circuit that generates a synchronizing clock at a multiple of the reference clock frequency.

### BACKGROUND OF THE INVENTION

A DPLL circuit is a PLL circuit in which all parts of the loop are digitally constituted. Since it does not require a voltage-controlled oscillator (VCO), there is no need to worry about frequency drift, which is primarily a function of variations in the power source; thus, it is very stable and reliable, Also, the circuit layout is less restrictive, which is beneficial for IC design. A conventional multiplier type DPLL circuit is composed of a control oscillator made up of a frequency divider that frequency-divides at the prescribed frequency division ratio of the master clock, which has a frequency sufficiently higher than that of the input reference clock to generate an output clock, a frequency divider for feedback that frequency-divides at a frequency division ratio corresponding to the multiplier for the output clock output from said control oscillator and generates a feedback clock at a frequency equal to that of the reference clock, and a phase comparator that compares the phase of the reference clock and the feedback clock and generates a synchronization control signal for controlling the locking operation of the control oscillator. Phase locking in the control oscillator is realized with the reference clock by controlling the counter operating frequency at high speed, low speed or intermediate speed with respect to the master clock corresponding to the synchronization control signal from the phase comparator, that is, corresponding to the phase difference between the reference clock and the feedback clock.

However, the conventional DPLL circuit has the following problem. That is, when the reference clock varies and its phase difference from the feedback clock increases, the period of the output clock becomes immediately disturbed, increasing jitter. Although this phenomenon is momentary, it is still undesirable for the DPLL circuit applications, especially in the fields of audio and image processing, because an increase in jitter of the DPLL output affects recording/reproduction and transmission quality of the audio and video information. Also, in a conventional DPLL circuit, the property of the control oscillator in tracking the phase difference between the reference clock and the feedback clock or the synchronization control signal from the phase comparator is limited. In particular, the counter operating frequency has a narrow range, so that the lock range is limited, which is also undesirable.

A general object of the present invention is to solve the aforementioned problems of the conventional methods by providing a digital phase-locked loop circuit that can alleviate the output jitter and produce a stable synchronizing clock.

### SUMMARY OF THE INVENTION

This and other objects and features are provided, in accordance with a first aspect of the invention by a first digital phase-locked loop circuit that generates a locked output clock at a frequency M-times (where M is an integer of 2 or more) that of the input prescribed reference clock, and comprises the following parts: a first frequency divider that divides the frequency of said reference clock to 1/M to generate a feedback clock, a first phase comparator that compares the phase of said reference clock and said feedback clock and generates a first synchronization control signal corresponding to the phase difference, a second frequency divider that divides the first master clock to 1/N (where N is an integer of 2 or more) according to the first synchronization control signal obtained by said first phase comparator and generates an intermediate clock at a frequency M-times that of said reference clock, a period measurement circuit that measures the period of each said intermediate clock generated by said second frequency divider, a moving average value computation circuit that determines the moving average value of the period of said intermediate clock based on the period measurement value obtained by said period measurement circuit, and an output clock generator that generates a clock having a period corresponding to the moving average value of the intermediate clock obtained by said moving average value computation circuit as said output clock.

In said first digital phase-locked loop circuit, because the second frequency divider follows the first synchronization control signal, even when there is a rapid variation in the period of the intermediate clock, a moving-averaged period that varies slightly with small fluctuations in magnitude can still be obtained by means of the period measurement circuit and the moving average value computation circuit, so that a stable output clock can be obtained that slowly and firmly follows the reference clock from the output clock generator.

According to another aspect of the present invention, said period measurement circuit has a time-measuring counter that counts the second master clock. Also, said moving average value computation circuit may have a sampling part that extracts at a prescribed shift pitch A period measurement values of the A (A is an integer of 2 or more) consecutive intermediate clock portions obtained by said period measurement circuit, and an average value computation circuit that determines the average value for said A period measurement values extracted by said sampling part. In addition, said output clock generator may have a counter for oscillation that counts the third master clock.

A third aspect of the invention includes, a hold control part that suspends the computation processing of said moving average value computation circuit so as to temporarily hold the output clock generated by said output clock generator constant. This hold function is especially effective when it is determined that the reference clock is disturbed or a disturbance in the reference clock can be detected.

A fourth aspect of the invention comprises said intermediate clock being generated by said second frequency divider and said output clock generated by said clock generator are inputs to a feedback control part which selects either the intermediate clock or output clock and outputs it to said first frequency divider. Said feedback control part has a phase-lock detector that detects whether the reference clock and the feedback clock are phase-locked, and said intermediate clock or said output clock is selected corresponding to the detection result of said phase-lock detector. In a preferred method, said phase-lock detector comprises the following parts: an edge detector that detects the rising edge or falling edge of said input clock as the first clock edge, and detects the rising edge or falling edge of said feedback clock as the second clock edge, a consecutive alternating input cycles counter that counts the consecutive number of cycles of alternating input of said first clock edge and said second clock edge, and a control signal output circuit that outputs a control signal for selecting said intermediate clock from a prescribed initial state until the count value of said consecutive alternating input cycles counter exceeds a prescribed value, and a control signal for selecting said output clock after the count value of said consecutive alternating input cycles counter exceeds the prescribed value. This method includes a counter control unit that resets the count value of said consecutive alternating input cycles counter to the initial value when the alternating input of said first clock edge and said second clock edge is not established.

According to a fifth aspect of the invention, a frequency-lock detector compares the period measurement value with said period measurement circuit and the moving average value obtained by said moving average value computation circuit to detect whether the frequency lock state has been established, and said intermediate clock or said output clock is selected corresponding to the detection result of said frequency-lock detector. In this way, in the feedback control part, not only phase-locking but also frequency-locking are checked to perform switching from the intermediate clock to the output clock. As a result, the overall control of the phase-locked loop can be made even more reliable.

In one aspect, the second digital phase-locked loop circuit of the present invention is a digital phase-locked loop circuit for generating a locked output clock at a frequency M-times (where M is an integer of 2 or more) that of the input prescribed reference clock and comprises the following parts: a first frequency divider that divides the frequency of said output clock to 1/M to generate a feedback clock, a first phase comparator that compare the phases of said input reference clock and said feedback clock and generates a first synchronization control signal corresponding to the phase difference, a second frequency divider that divides the first master clock to 1/N (where N is an integer of 2 or more) according to the first synchronization control signal obtained by said first phase comparator and generates an output clock at a frequency M-times that of said reference clock, a second phase comparator that compares the phase of said reference clock and said feedback clock to generate a second synchronization control signal corresponding to the phase difference, and a frequency division ratio control part that controls and adjusts frequency division ratio N of said second frequency divider corresponding to the second synchronization control signal obtained by said second phase comparator.

In said second digital phase-locked loop circuit, the operation of the second phase comparator and the frequency division ratio control part adjusts and controls the frequency division ratio N of the second frequency divider in accordance with the phase difference between the reference clock and the feedback clock, so that the output frequency range of the second frequency divider for maintaining phase-locking, that is, the lock range, can be wider.

In another aspect of the present invention, said second phase comparator detects the phase difference between said reference clock and said feedback clock at a sensitivity lower than that of said first phase comparator. More preferably, a second synchronization control signal is output when the phase difference between the reference clock and the feedback clock exceeds the prescribed range. In a preferred method, said frequency division ratio control part has a range counter that sets the reference frequency division ratio as the count initial value for said second frequency divider, and adjusts the count value corresponding to said second synchronization control signal from said second phase comparator.

The constitution of the second phase comparator and frequency division ratio control part in said second digital phase-locked loop circuit may be the same as that of said first digital phase-locked loop circuit. It is then possible, through a synergistic effect to further reduce output jitter and to improve tracking ability.

In a seventh aspect of the invention, the second frequency divider of both said first and second digital phase-locked loop circuits may have a counter for frequency division that counts the first master clock at the counter operating frequency corresponding to the first synchronization control signal from the first phase comparator. In a more preferred method, the second frequency divider may have a 1-bit counter that counts said first master clock at the counter operating frequency corresponding to the first synchronization control signal from said first phase comparator, and a pre-scaler that counts the clock output from said 1-bit counter and generates said intermediate clock. Here, in a preferred method, the 1-bit counter has the following count modes: a first count mode that counts one for every two clocks of said first master clock, a second count mode that counts three for every four clocks of said first master clock corresponding to the first synchronization control signal from said first phase comparator, which represents the phase delay of said feedback clock with respect to said reference clock, and a third count mode that counts one for every four clocks of said first master clock corresponding to the first synchronization control signal from said first phase comparator, which represents the phase advance of said feedback clock with respect to said reference clock. In this case, if the frequency of the first master clock is fm, in the first count mode, the first master clock is counted at a counter operating frequency of fm/2; in the second count mode, the first master clock is counted at a counter operating frequency of fm/4; and in the third count mode, the first master clock is counted at a counter operating frequency of 3fm/4.

### BRIEF DESCRIPTION OF THE DRAWINGS

FIG. 1 is a block diagram illustrating the constitution of the DPLL circuit in Embodiment 1 of the present invention.

FIG. 2 is a block diagram illustrating an example of the circuit constitution of the up/down counter in the DPLL circuit of Embodiment 1.

FIG. 3 is a timing diagram illustrating the operation of the up/down counter in the DPLL circuit of Embodiment 1.

FIG. 4 is a timing diagram illustrating the operation of the various parts in the phase-locked loop in the DPLL circuit in Embodiment 1.

FIG. 5 is a timing diagram illustrating an example of the operation in which the feedback signal is switched in the DPLL circuit of Embodiment 1.

FIG. 6 is a block diagram illustrating an example of the circuit constitution of the phase-lock detector in the DPLL circuit of Embodiment 1.

FIG. 7 is a diagram illustrating an example of state transitions of the phase-lock detector in Embodiment 1.

FIG. 8 is a timing diagram illustrating the operation of the phase-lock detector in the DPLL circuit of Embodiment 1.

FIG. 9 is a block diagram illustrating the constitution of the DPLL circuit in Embodiment 2.

FIG. 10 is a timing diagram illustrating the operation of the various parts of the phase-locked loop in the DPLL circuit of Embodiment 2.

### REFERENCE NUMERALS AND SYMBOLS AS SHOWN IN THE DRAWINGS

In the figures, 10 represents a phase comparator, 12 represents a control oscillating part, 14 represents a feedback part, 16 represents a feedback frequency divider, 18 represents an intermediate oscillating frequency divider, 20 represents a period measurement circuit, 22 represents a moving average value computation circuit, 24 represents an output clock generator, 26 represents a master clock generator, 28 represents an up/down counter, 30 represents a pre-scaler, 38 represents a phase-lock detector, 40 represents a clock selecting circuit, 52 represents a hold control part, 54 represents a phase comparator, 56 represents a range counter, 58 represents a frequency-lock detection.

### DESCRIPTION OF THE EMBODIMENTS

The digital phase-locked loop (DPLL) circuit of the present invention makes it possible to reduce output jitter and obtain a stable synchronizing clock; it is also possible to improve the tracking ability of the control oscillation part and expand the lock range.

In the following, preferred embodiments of the present invention will be explained with reference to appended figures.

### EMBODIMENT 1

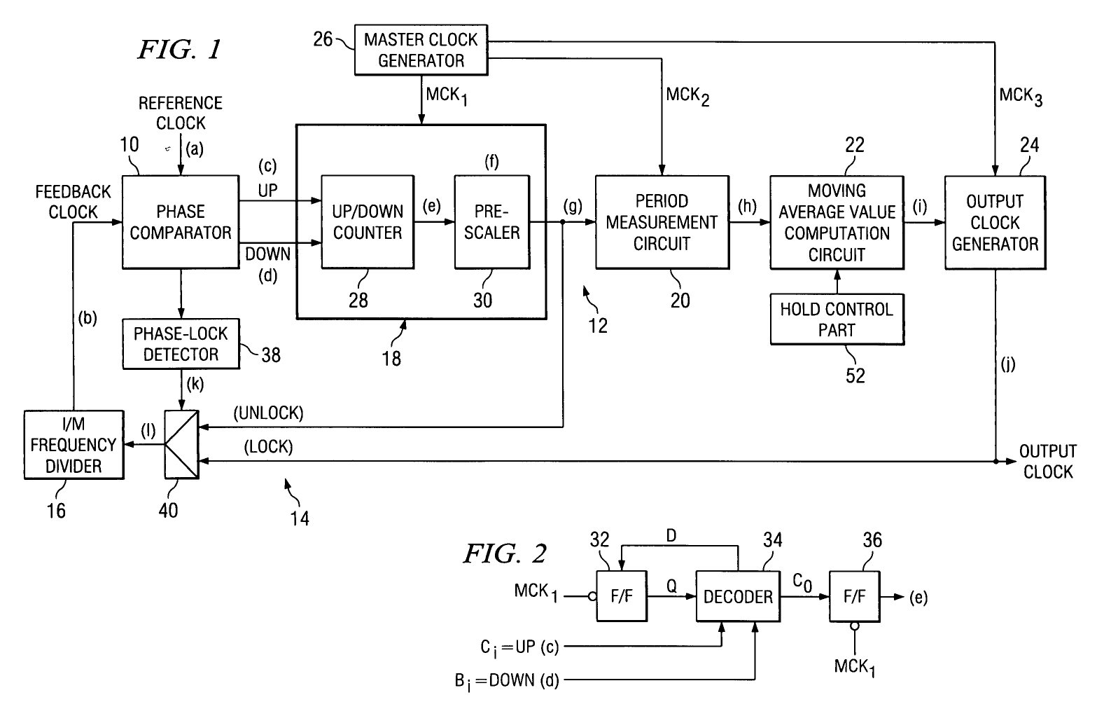

FIG. 1 is a diagram illustrating the constitution of the digital phase-locked loop (DPLL) circuit in Embodiment 1 of the present invention. The DPLL circuit of this embodiment is a multiplier DPLL circuit that generates locked output clock j at a frequency M-times (where M is an integer of 2 or larger) that of input reference clock a. Generally speaking, it is has a phase-locked loop composed of phase comparator 10, control oscillation part 12 and feedback part 14.

Feedback part 14 contains frequency divider 16 that generates feedback clock b at 1/M times the frequency division for of output clock j. Phase comparator 10 compares the phase of reference clock a and feedback clock b, and outputs digital synchronization control signals c, d corresponding to the phase difference. More specifically, from the difference in time between the edge of reference clock a and the edge of feedback clock b, the lead/lag relationship or phase difference between the two clocks is detected, and either up-count enable signal c or down-count enable signal d of the square wave pulse is selected and output corresponding to the lead/lag relationship during the period from the edge of the leading clock to the edge of the lagging clock. Here, said up-count enable signal c is output when feedback clock b lags reference clock a. On the other hand, down-count enable signal d is output when feedback clock b leads reference clock a.

Control oscillation part 12 includes frequency divider 18, period measurement circuit 20, moving average value computation circuit 22, and output clock generator 24. Master clocks MCK1, MCK2, and MCK3 from master clock generator 26 are input to frequency divider 18, period measurement circuit 20, and output clock generator 24, respectively.

Frequency divider 18 is a pre-oscillator or intermediate oscillator. It is composed of up/down counter 28 and pre-scaler 30. Said up/down counter 28 is composed of 1-bit counters that count master clock MCK1 according to synchronization control signals c, d from phase comparator 10.

For example, as shown in FIG. 2, up/down counter 28 has D-type flip-flop circuit 32 and decoder 34. Flip-flop circuit 32 retrieves and latches operation output D of decoder 34 at the clock timing of master clock MCK1, that is, the falling edge. Decoder 34 is an adder, into which is input the latched output from flip-flop circuit 32 and up-count enable signal c and down-count enable signal d from phase comparator 10 as carry-in Cᵢ and borrow Bᵢ respectively. It performs the following addition operation, and outputs arithmetic operation result D and carry-out C₀. Flip-flop circuit 36 in the output section latches carry-out Cₒ, delays it by 1 clock, and then outputs it as counter output e. When carry-out Cₒ is output unmodified as counter output e, said flip-flop circuit 36 is omitted.

$$D = ( Q + {C}_{1} - {B}_{1} + 1 ) \% 2 ( {2}^{′} s complement arithmetic )$$

$$\begin{matrix}{C}_{0} = 1 ( {C}_{1} = 1 , {B}_{1} = 0 ) \\ = 0 ( {C}_{1} = 0 , {B}_{1} = 1 ) \\ = Q ( {C}_{1} = 0 , {B}_{1} = 0 )\end{matrix}$$

In the above arithmetic equation for D, 2% stands for twos complement arithmetic. The remainder obtained by dividing the value in parenthesis by 2 corresponds to D. Also, it is assumed that carry-in Cᵢ (up-count enable signal c) and borrow Bᵢ (down-count enable signal d) cannot be “1” at the same time. That is, as explained above phase comparator 10 either outputs both, up-count enable signal c and down-count enable signal d, but not at the same time, or only one enable signal.

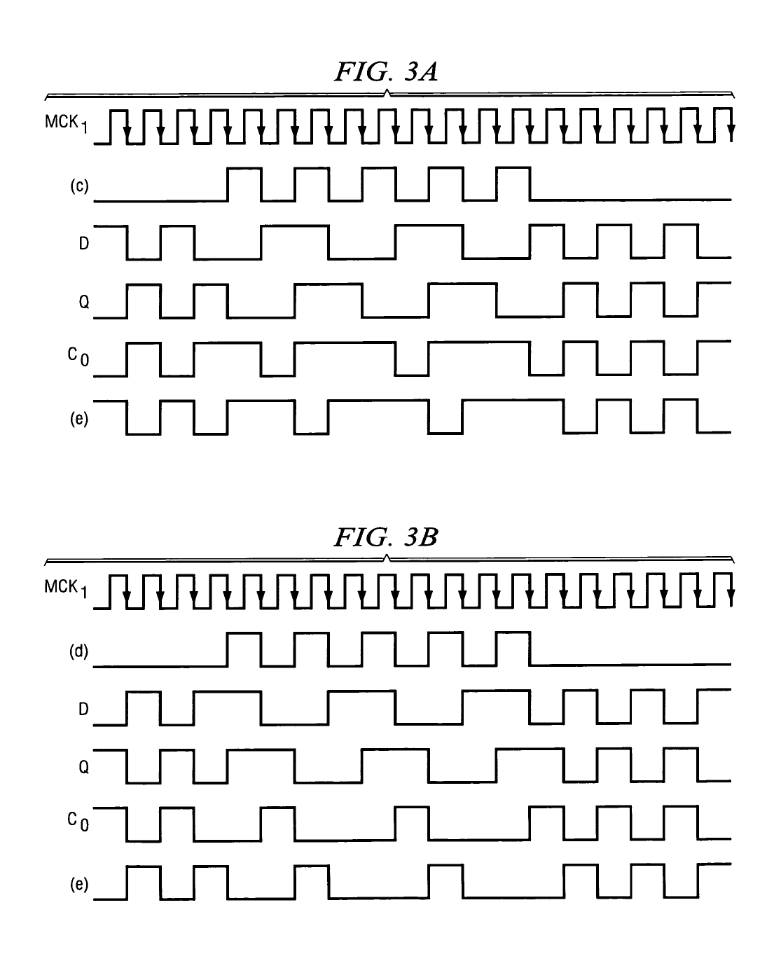

FIGS. 3A, B show the signal waveforms of the various portions in up/down counter 28 when up-count enable signal c or down-count enable signal d are output as synchronization control signals from phase comparator 10. As far as the relationship between master clock MCK1 and carry-out Cₒ is concerned, during the period when neither up-count enable signal c nor down-count enable signal d is output, carry-out Cₒ becomes “1” in one out of two periods of master clock MCK1. That is, in this case, up/down counter 28 counts one for every two clocks of master clock MCK1. On the other hand, during the period when up-count enable signal c is output, up/down counter 28 counts three for every four clocks of master clock MCK1, and carry-out Cₒ is “1” in three out of four periods of master clock MCK1. Also, during the period when down-count enable signal d is output, up/down counter 28 counts one for every four clocks of master clock MCK1, and carry-out Cₒ is “1” in one out of four periods of master clock MCK1.

In this way, up/down counter 28 performs the counting operation at a counting frequency of fm/4˜3fm/4 for peak-to-peak with respect to frequency fm of master clock MCK1. Especially, when feedback clock b leads reference clock a, the counting operation is performed in the up-count mode of 3fm/4 corresponding to up-count enable signal c from phase comparator 10. On the other hand, when feedback clock b lags reference clock a, the counting operation is performed in the down-count mode of fm/4 corresponding to down-count enable signal d from phase comparator 10.

As shown in FIG. 1, pre-scaler 30 is formed as a 1-bit counter with the following operation: output e of up/down counter 28 is retrieved at the clock timing of master clock MCK1, and only when e is “1” is count value f counted up for one, and when count value f reaches preset value P, the logic value of output g is inverted. For example, when master clock MCK1 is frequency divided to 1/N in frequency divider 18, the half-value Ns/2 of reference frequency division ratio Ns is given as preset value P to pre-scaler 30. During the period of counting of count value f from initial value 0 to preset value P, pre-scaler 30 outputs intermediate clock g of one cycle. Consequently, the period of intermediate clock g output from pre-scaler 30 varies corresponding to output e of up/down counter 28. That is, during the period when up/down counter 28 is in steady-state operating mode of counter operating frequency fm/2, the period of intermediate clock g is kept at the reference period of a steady value (constant value), and the period of intermediate clock g generated when up/down counter 28 operates in the up-count mode at counter operating frequency of 3fm/4 becomes shorter than the reference period. The period of intermediate clock g generated when up/down counter 28 operates in the down-coTI36908—Utility Patent Application—WBK—08/31/05unt mode at counter operating frequency of fm/4 becomes longer than the reference period.

Period measurement circuit 20 contains a counter for time measurement that operates at master clock MCK2, and as explained above, it measures the time with a period of each intermediate clock g output from pre-scaler 30 taken as count value h. Consequently, for example, when a certain period of intermediate clock g is equal to said reference period, time-measuring count value h equal to said reference frequency division ratio Ns is obtained by period measurement circuit 20 with respect to one period.

Moving average value computation circuit 22 retrieves the period measurement values obtained successively by period measurement circuit 20 for a period of each clock g output from pre-scaler 30 as time-measuring count values h, and computes moving average value i. Typically, A (where A is an integer of 2 or more) consecutive period measurement values h of intermediate clock g obtained from period measurement circuit 20 are sampled, and the average value of the A period measurement values h is determined. On the time axis, the sampling range is shifted at a prescribed shifting pitch, and the aforementioned average value computation is carried out repeatedly, and each average value obtained in time sequence is output as moving average value i. Although the value of the shifting pitch can be selected as desired, it is usually set to “1”, and the sampling for each cycle is performed in the form of picking one period measurement value (h) at the head and one period measurement value (h) at the tail on the time axis in turn. Also, the same function can be realized by means of a lowpass filter.

Output clock generator 24 is a control oscillator of the output section. It contains a counter that counts master clock MCK3, with moving average values i given successively from moving average value computation circuit 22 as preset values, and generates output clock i with each moving average value i used as the period.

As shown in FIG. 1, master clocks MCK1, MCK2, MCK3 from master clock generator 26 are sent to intermediate oscillating frequency divider 18, period measurement circuit 20, and output clock generator 24, respectively. The other parts in this DPLL circuit, that is, phase comparator 10, feedback frequency divider 16, moving average value computation circuit 22, phase-lock detector 38, etc. operate with the same master clock or the basic clock.

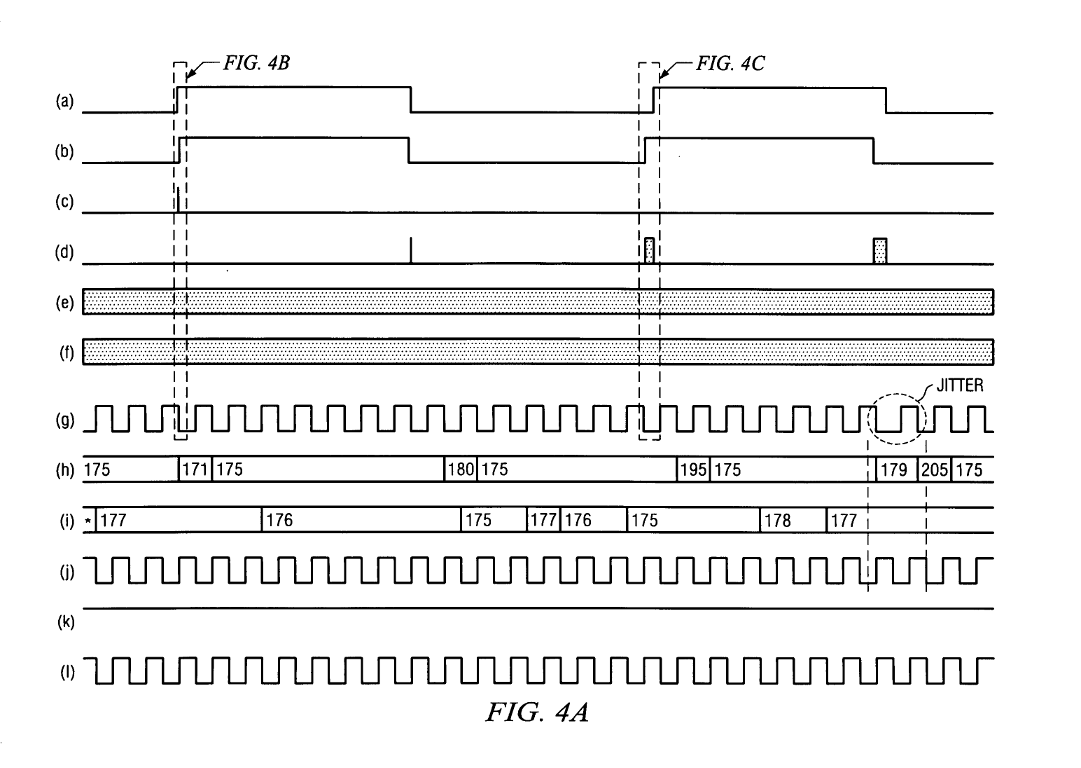

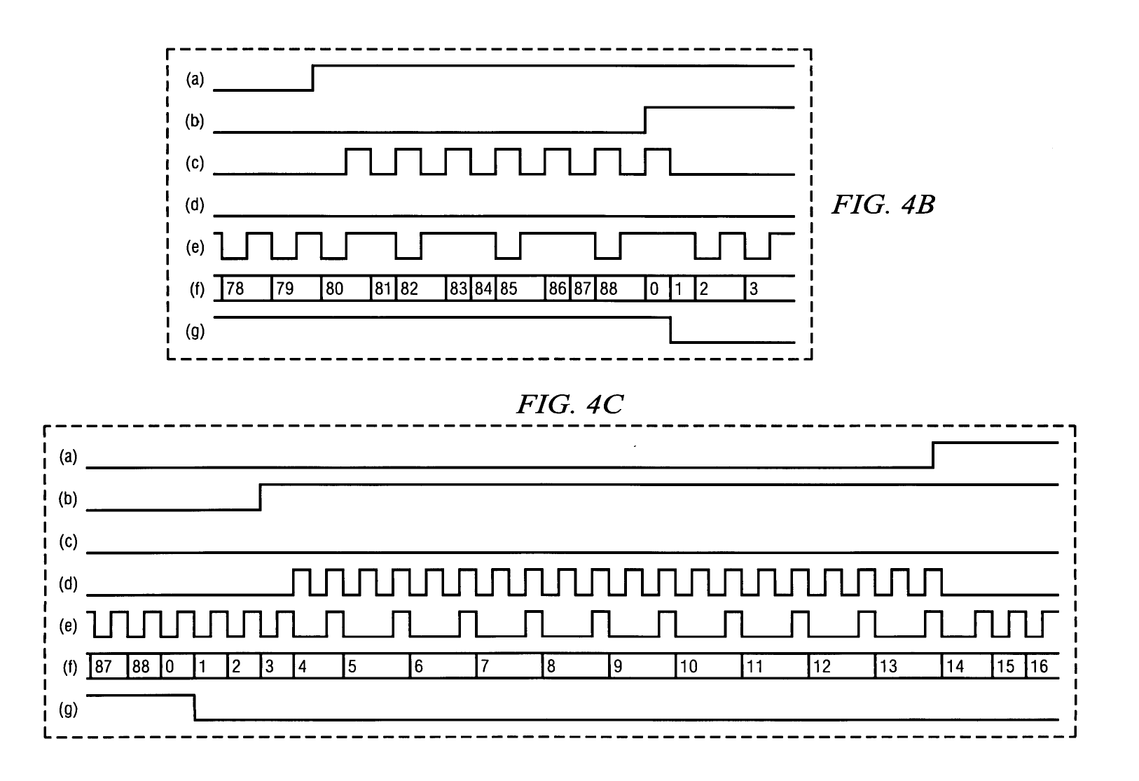

FIG. 4 is a timing diagram illustrating the functions of the various parts of said phase-locked loop of said DPLL circuit. In this example, frequency division ratio M of feedback frequency divider 16 is set to “14”, and preset value P of pre-scaler 30 of intermediate oscillating frequency divider 18 is set to “89”.

As explained above, phase comparator 10 compares the phase between the corresponding edges (rising edges or falling edges) of reference clock a and feedback clock b, and, corresponding to the phase difference, either up-count enable signal c or down-count enable signal d is selected and output.

In the case of FIG. 4A B, as shown in an enlarged view in FIG. 4B, feedback clock b lags reference clock a; during the period from the rising edge of reference clock a to the rising edge of feedback clock b, up-count enable signal c is repeatedly output from phase comparator 10 at ½ the frequency of master clock MCK1 (fm/2). As a result, the counting speed of up/down counter 28 and pre-scaler 30 of intermediate oscillating frequency divider 18 increases, and the period of intermediate clock g decreases. In the example shown in the figure, the period of intermediate clock g measured by period measurement circuit 20, which is “177” immediately before the phase comparison is performed, is reduced to “171” corresponding to the phase comparison result.

In the case of FIG. 4A C, as shown in an enlarged view in FIG. 4C, feedback clock b leads reference clock a; during the period from the rising edge of feedback clock b to the rising edge of reference clock a, down-count enable signal c is repeatedly output from phase comparator 10 at ½ the frequency of master clock MCK1 (fm/2). As a result, the counting speed of up/down counter 28 and pre-scaler 30 of intermediate oscillating frequency divider 18 decreases, and the period of intermediate clock g increases. In the example shown in the figure, the period of intermediate clock g, which is “175” immediately before the phase comparison is performed, is increased to “195” corresponding to the phase comparison result.

In this way, in intermediate oscillating frequency divider 18, as a result of tracking synchronization control signals c, d from phase comparator 10, the period of intermediate clock g fluctuates widely. However, the wide variation in the period of intermediate clock g is relieved by calculating the moving average with shift value computation circuit 22, so that it appears as a small variation in moving average value i. In the example shown in FIG. 4, while the period of intermediate clock g varies with a magnitude of about ±5˜30, moving average value i varies slightly with a fluctuation magnitude of about ±1˜3. As a result, output clock j obtained from output clock generator 24 can track reference clock a slowly and reliably. Consequently, even when reference clock a varies and the phase difference with respect to feedback clock b increases, there is still no significant increase in the output jitter, and the phase-locked state can be maintained stably.

In this embodiment, clock selection circuit 40 is set in feedback part 14. Output clock j from output clock generator 24 and intermediate clock g from intermediate oscillating frequency divider 18 are input to clock selection circuit 40. Under control of phase-lock detector 38, either clock j or clock g is selected and sent to feedback frequency divider 16. In this DPLL circuit, when the phase-locked state is not established, a brief time is required before the period of output clock j, which is defined by a moving average established. Consequently, the time for feeding back the intermediate clock g with a high response sensitivity can be shorter than that for feedback of output clock j with a low response sensitivity.

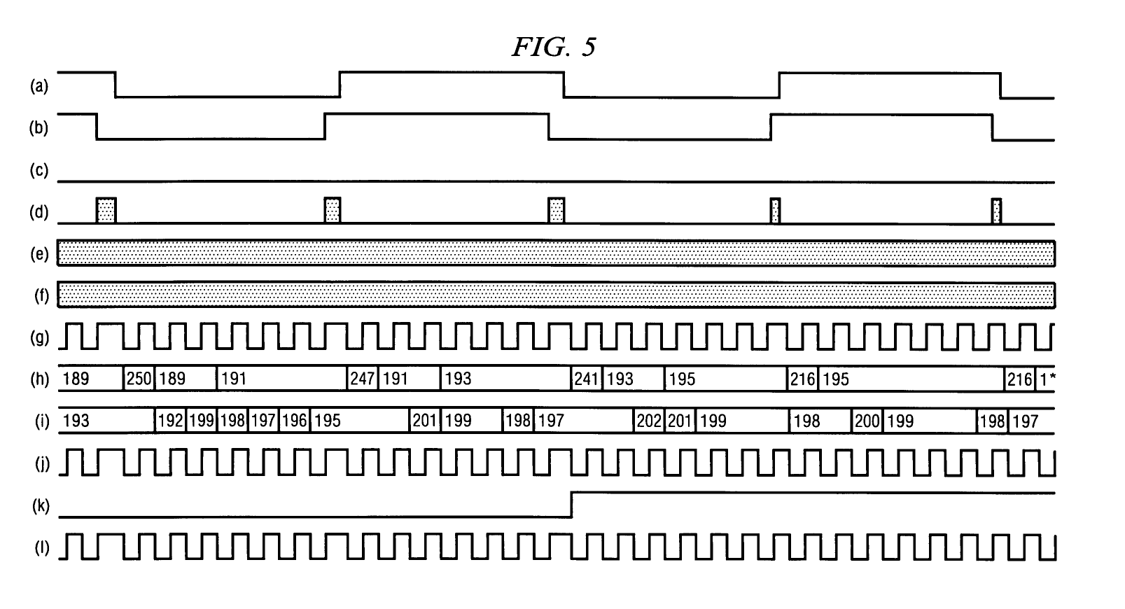

FIG. 5 is a diagram illustrating an example of clock selection or switching in clock selecting circuit 40. As shown in the figure, when the control signal from phase-lock detector 38, that is, clock selection signal k, has logic value L, the phase-lock state has not yet been established, and clock selecting circuit 40 selects intermediate clock g. Once the phase-lock state is established, clock selection signal k changes from logic value L to logic value H, and clock selecting circuit 40 selects output clock j. In the example shown in FIG. 5, reference frequency division ratio Ns in intermediate oscillating frequency divider 18 and pre-scaler present value P are different from those in FIG. 4.

When this DPLL circuit is designed, for example, so that phase-locking occurs at the rising edges of reference clock a and feedback clock b, the phase difference between reference clock a and feedback clock b will be within the range of ±180° as long as the rising edge of reference clock a and the falling edge of feedback clock b are input alternately and repeatedly. A prescribed amount of time is required to establish an appropriate phase comparison. As will be explained below, in phase-lock detector 38 of this embodiment, the consecutive number of cycles with alternating and repeated rising edges of reference clock a and falling edges of feedback clock b are counted, and the output signal, that is, clock selection signal k, is kept at logic value L (clock selection circuit 40 selects intermediate clock g until the count value exceeds a preset value). Once the count value exceeds the preset value, clock selection signal k goes to logic value H (clock selecting circuit 40 selects output clock j).

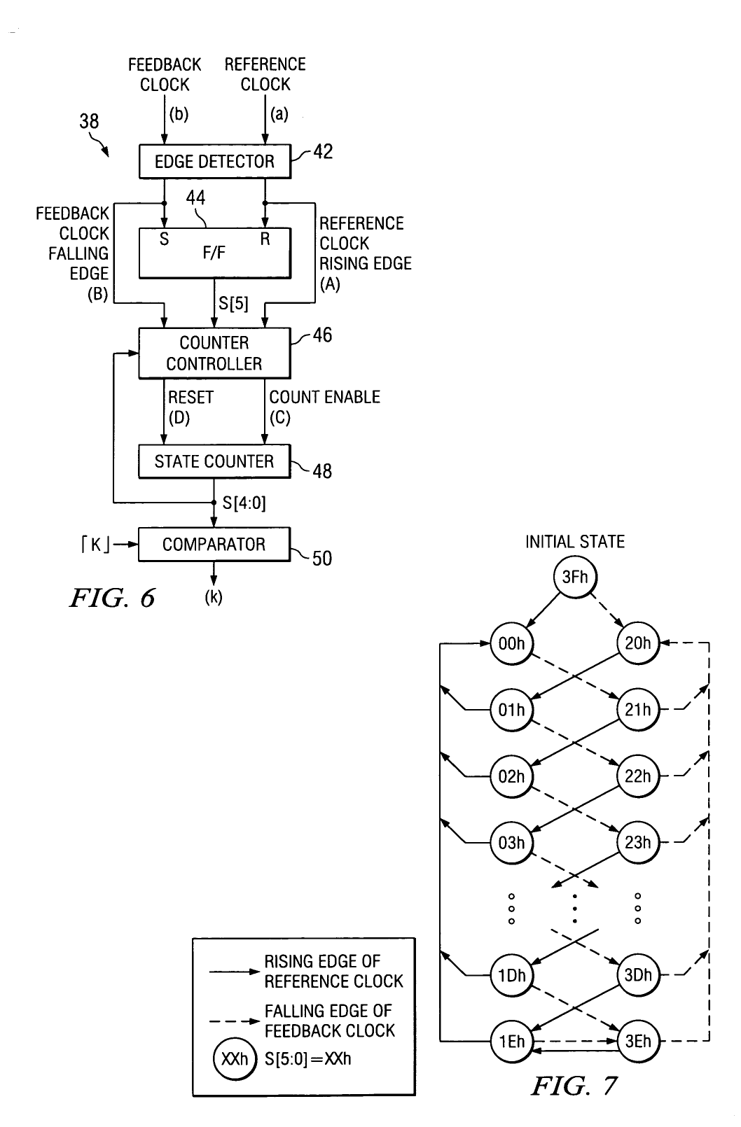

FIG. 6 is a diagram illustrating an example of the constitution of phase-lock detector 38. Phase-lock detector 38 includes edge detector 42, RS flip-flop circuit 44, counter controller 46, state counter 48, and comparator 50. Reference clock a and feedback clock b are input to edge detector 42, which detects the rising edge input of reference clock a and falling edge input of feedback clock b. Edge detector 42 includes a pair of outputs A, B. During the period when neither the rising edge of reference clock a nor the falling edge of feedback clock b is input, A=L, B=L. When the rising edge of reference clock a is detected, A=H, B=L. When the falling edge of feedback clock b is detected, A=L, B=H.

RS flip-flop circuit 44 latches outputs a, b of edge detector 42 and holds the following logic values: L for output S[5] when A=H and B=L; H for output S[5] when A=L and B=H; and the logic value for S[5] when A=L and B=L. While output S[5] of RS flip-flop circuit 44 is used as a reference for a flag that records or holds the preceding clock edge input, counter controller 46 retrieves outputs a, b of edge detector 42, and each time the output A=L and B=H appears alternately between the output A=L, B=L and the output A=H, B=L, the 5-bit count value S[4:0] of state counter 48 is incremented by one. Comparator 50 holds the comparison output signal, that is, clock selection signal k at L until count value S[4:0] of state counter 48 exceeds preset value K, and when count value S[4:0] exceeds preset value K, clock selection signal k goes to H. That is, when the rising edge input of reference clock a and the falling edge input of feedback clock b alternate consecutively for K cycles, the determination is made that the phase-locked state is established, and clock selection signal k is switched from L to H. On the other hand, when the output A=H, B=L or the output A=L, B=H occurs twice consecutively with the output of A=L, B=L between them, counter controller 46 resets state counter 48, and count value S[4:0] returns to the initial value “00000”.

FIG. 7 shows an example of a state transition of phase-lock detector 38. The 1-bit output S[5] (preceding clock edge input hold flag) of RS flip-flop circuit 44 and the 5-bit output S[4:0] (consecutive number of cycles with alternating clock edge inputs) of state counter 48 are merged to form 6-bit state information S[5:0] that is represented as a hexadecimal number. As shown in FIG. 7, for example, when the state information S[5:0] is “02h”, it is “0000010” in binary representation, and S[5]=0, S[4:0]=00010. In this state, when the falling edge input of feedback clock b is detected, S[5]=1, S[4:0]=00011, and the state information S[5:0] makes a transition to “00100011”, that is, “23h”. However, in this state, when the rising edge input of reference clock a is detected, the alternating input of the clock edges is not established. With S[5]=0 as is, output S[4:0] of state counter 48 is initialized to “00000”, and state information S[5:0] returns from “02h” to “00000000”, that is, “00h”. Also, the initial value of “3Fh” is an example.

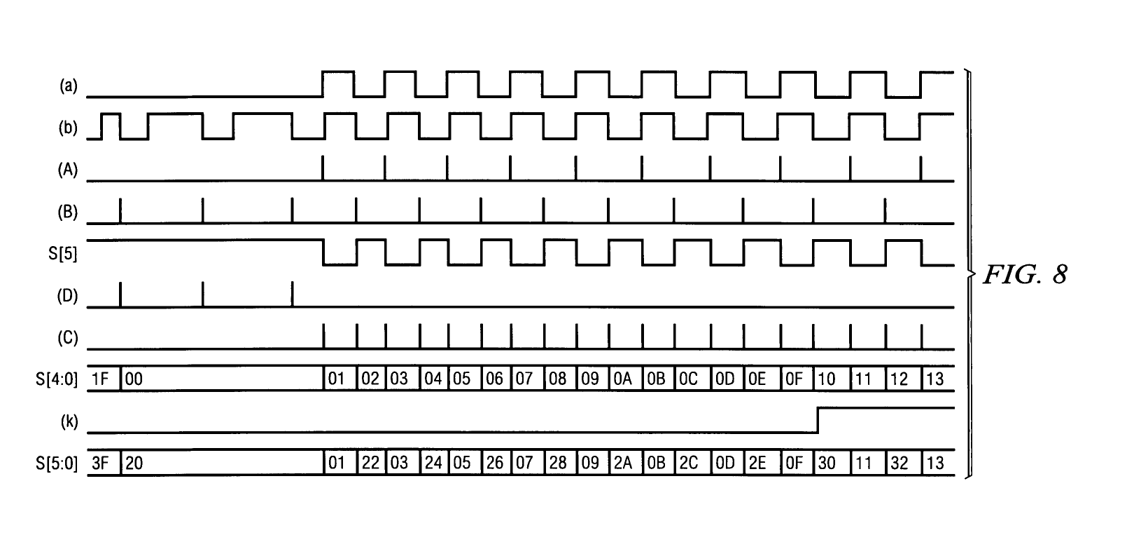

FIG. 8 is a timing diagram illustrating the operation of phase-lock detector 38. In this example, preset value K with respect to state counter 48 is set at “0Fh”, and at the time when count value S[4:0] of state counter 48 exceeds “0Fh”, clock selection signal k is switched from L to H. Also, count value S[4:0] is represented as a hexadecimal number.

As shown in FIG. 8, during the period when reference clock a is not input, edge detector 42 outputs A=L, B=H at each falling edge of feedback clock b, state counter 48 is reset by counter controller 46, and the count value S[4:0] is kept at the initial value “00h”. Also, output S[5] of flip-flop circuit 44 is kept at H. When the input of reference clock a begins, the rising edge of input reference clock a and the falling edge of input feedback clock b appear alternately and repeatedly, the logic value of preceding clock edge input hold flag S[5] is inverted, and, at the same time, the count value S[4:0] is incremented by one so that “01h”→“02h”→“03h”→ . . . Then, when count value S[4:0] reaches “10h”, that is, when S[4:0]>preset value “0Fh”, clock selection signal k is switched from L to H.

In the aforementioned example, the rising edge of reference clock a and the falling edge of feedback clock b are combined, and the alternating input of the clock edges is monitored. However, it is also possible to have a combination of the falling edge of reference clock a and the rising edge of feedback clock b. Also, when the design is such that phase-locking occurs between the rising edge of either reference clock a or feedback clock b and the falling edge of the other clock, said alternating inputs with a combination of the rising edges or a combination of the falling edges of said two clocks a, b may also be monitored.

In practical applications, disturbances in reference clock a are determined beforehand, or disturbance in reference clock a may be determined. For example, applications of DVD (digital versatile disc) or other optical disk devices in which the wobble signal is used as the reference clock and its multiplier M synchronization clock is generated, may required that the wobble signal be ignored in defective portions of discs with defective wobble, and also that the period of the synchronization clock have as little disturbance as possible. Hold control part 52 is arranged in the DPLL circuit of this embodiment. In this case, a defect signal is input to hold control part 52 as a hold instruction signal, so that hold control part 52 can stop the arithmetic operations of moving average value computation circuit 22, and the moving average value i is held. As a result, the period of output clock j generated by output clock generator 24 is held at the period immediately before the defect signal is given. For reasons of stability, it is preferred that during the hold time clock selecting circuit 40 of feedback part 14 select the side of output clock j. When the defect signal is released, hold control part 52 starts the arithmetic operation of moving average value computation circuit 22 again.

### EMBODIMENT 2

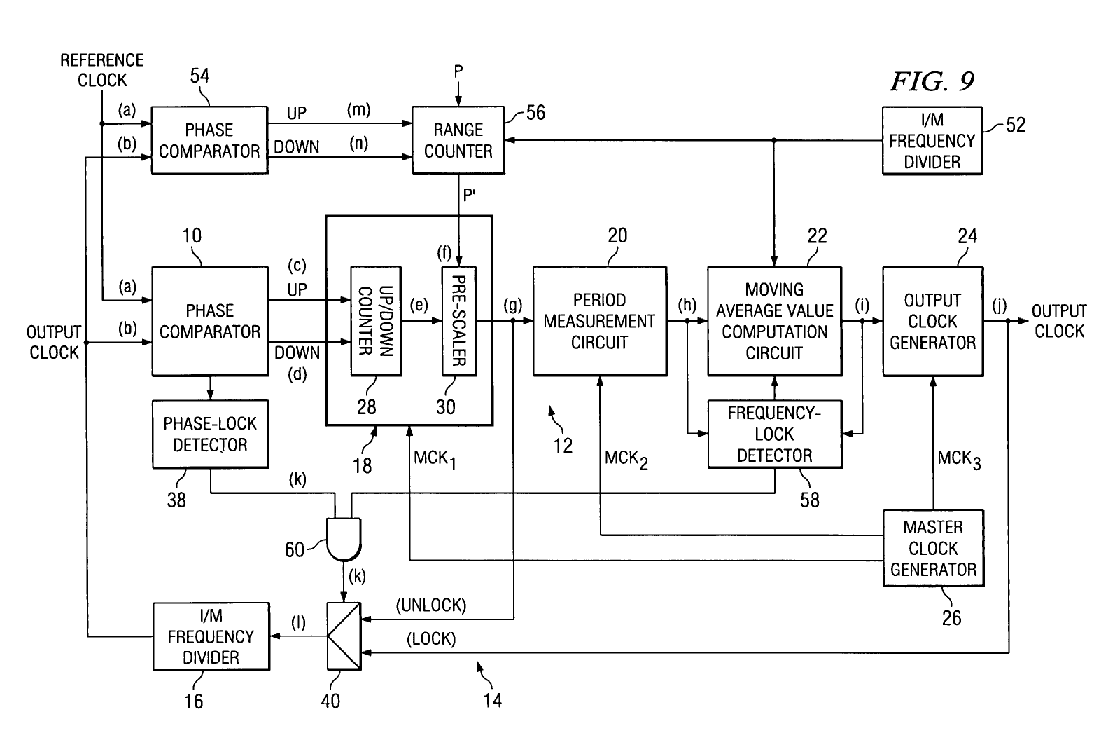

FIG. 9 is a diagram illustrating the constitution of the DPLL circuit in Embodiment 2. Part numbers used in Embodiment 1 (FIG. 1) that correspond to parts with the same constitutions and functions are used here. The most significant characteristic feature of Embodiment 2 is that phase comparator 54 and range counter 56 improve lock range.

Like phase comparator 10, phase comparator 54 compares the phase of reference clock a and feedback clock b, and corresponding to the phase difference, outputs digital synchronization control signals m, n. The phase comparator has a lower phase difference detection sensitivity than phase comparator 10, and when the phase difference between the two clocks a, b exceeds a prescribed upper limit (e.g., ⅛ of a period), corresponding to the lead/lag relationship between the two clocks, it selectively outputs either up-count enable signal m or down-count enable signal n of the square wave pulse. Here, said up-count enable signal m is output when feedback clock b leads reference clock a and the phase difference exceeds the upper limit. On the other hand, said down-count enable signal n is output when feedback clock b lags reference clock a and the phase difference exceeds the upper limit. Said upper limit may be for the phase difference obtained in a single phase comparison cycle, or it may be for the accumulated value or the moving average value of the phase difference obtained by means of several phase comparison cycles. Consequently, output signal m, n of phase comparator 54 are not abrupt, and in many cases, even if either of up-count enable signal c or down-count enable signal d is output from phase comparator 10, neither up-count enable signal m nor down-count enable signal n will be output from phase comparator 54 if the phase difference between the two clocks a, b does not exceed the upper limit.

Said up-count enable signal m or down-count enable signal n output from phase comparator 54 is sent to range counter 56. Range counter 56 functions as a frequency division ratio control part of frequency divider 18. Preset value P (a constant value) output to pre-scaler 30 of intermediate oscillating frequency divider 18 in Embodiment 1 is set as the initial value or reference value, and said up-count enable signal m and down-count enable signal n from phase comparator 54 initiate up-counting and down-counting respectively, and reference value P is increased/decreased to generate count value P′. This count value P′ is sent as corrected preset value to pre-scaler 30.

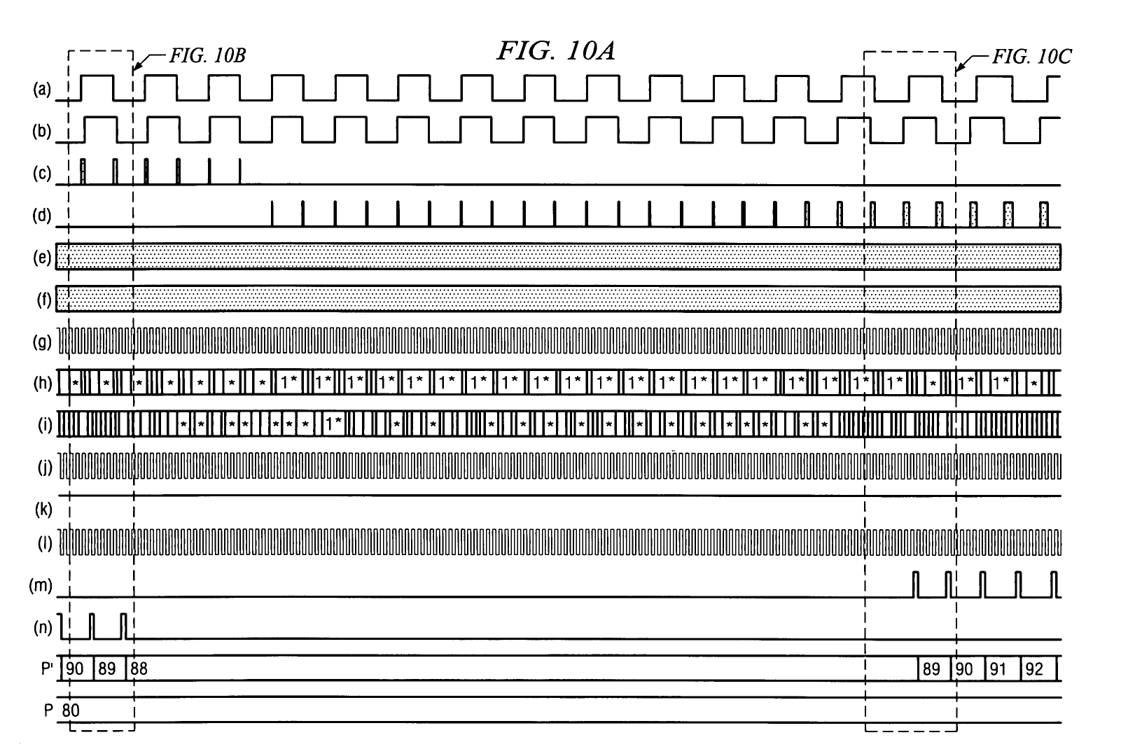

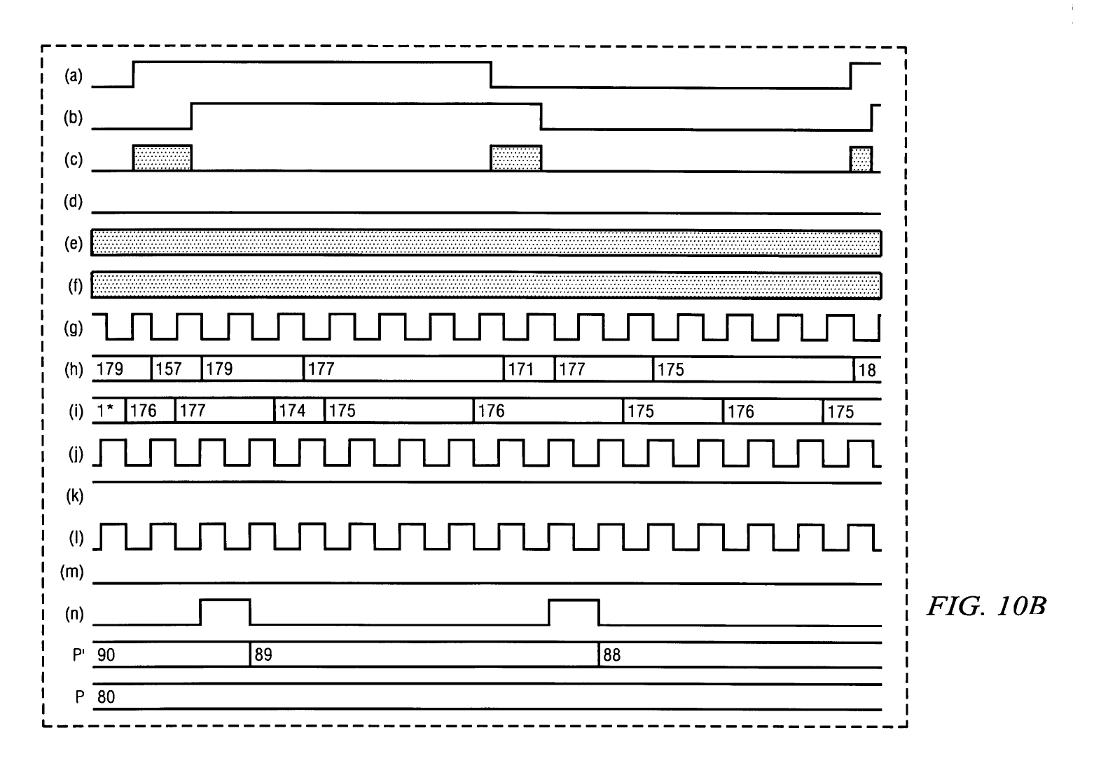

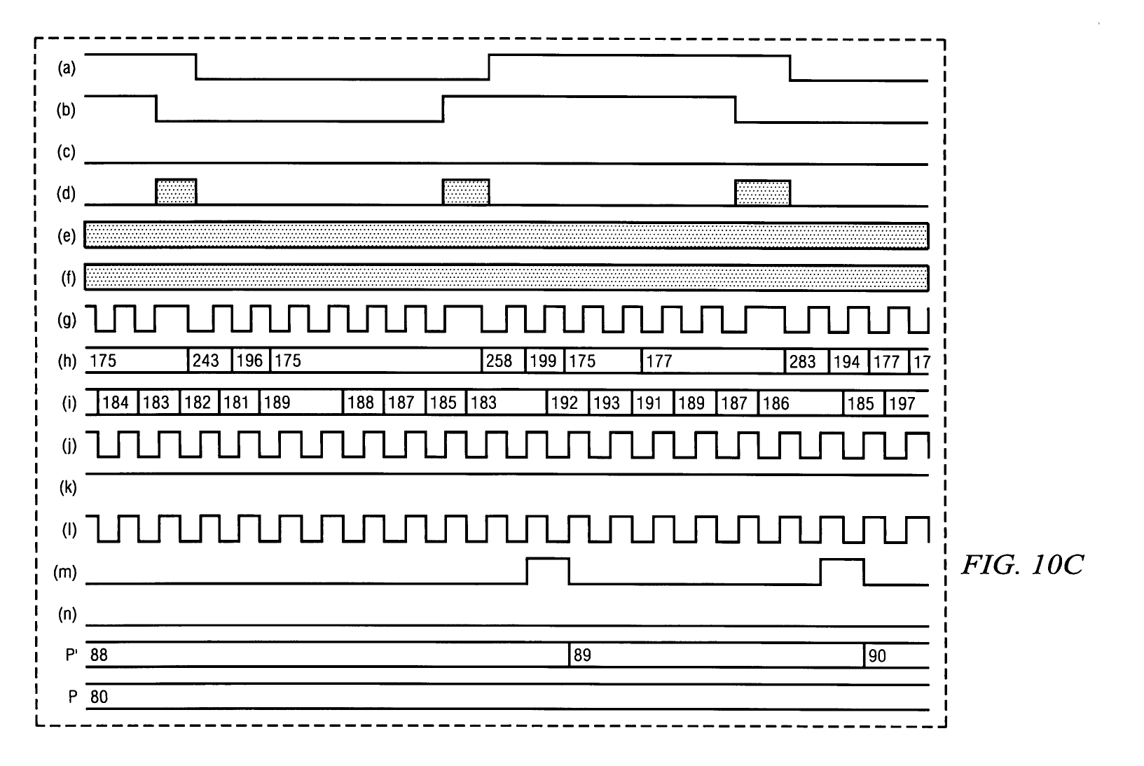

FIG. 10 is a timing diagram illustrating the functions of the various parts of the DPLL circuit of Embodiment 2. In this example, frequency division ratio M in feedback frequency divider 16 is set to “14”, and preset value P for range counter 56 is set to “80”.

In the case shown in FIG. 10A B, as illustrated in an enlarged view in FIG. 10B, feedback clock b lags reference clock a by more than the upper limit, and down-count enable signal n is output from phase comparator 54. As a result, each time a single-pulse signal n is input to range counter 56, the count value P′ of range counter 56 is decremented one. Since corrected preset value P′ is decreased with respect to pre-scaler 30 in this way, each cycle of intermediate clock g in frequency divider 18 is reduced, and the phase-locked loop works in the direction of advancing the phase of output clock j.

On the other hand, in the case shown in FIG. 10A C, as illustrated in an enlarged view in FIG. 10C, feedback clock b leads reference clock a by more than the upper limit, and up-count enable signal m is output from phase comparator 54. As a result, each time a single-pulse signal m is input to range counter 56, the count value P′ of range counter 56 is increased by one. Since corrected preset value P′ is increased with respect to pre-scaler 30 in this way, each cycle of intermediate clock g in frequency divider 18 is lengthened, and the phase-locked loop works in the direction of delaying the phase of output clock j.

As explained above, since up/down counter 28 of frequency divider 18 counts at the counter operating frequency fm/4˜3fm/4 from peak to peak with respect to frequency fm of master clock MCK1, the output frequency of pre-scaler 30 is limited to the range of fm/4P˜3fm/4P. In Embodiment 2, by replacing preset value P of pre-scaler 30 with a variable corrected preset value P′ (P−α˜P+β) (here, α and β are positive numbers), the output frequency of pre-scaler 30 is extended to the range of fm/4(P+β)˜3fm/4(p−α). Here, the ratio of the upper limit to the lower limit is 3(P+β)/(P−α). In said Embodiment 1, α=0, β=0, so that μ=3. In Embodiment 2, for example, if α=0.2P and β=0.2P, then μ=4.5 (1.5-timer). That is, the output frequency of pre-scaler 30 that can maintain the phase locked state is extended 1.5-times, so that the lock range of said DPLL circuit is extended to 1.5-times.

In addition, in this embodiment, frequency-lock detector 58 is used. Frequency-lock detector 58 compares the period measurement value h obtained by period measurement circuit 20 for one period of each intermediate clock g output from pre-scaler 30 with moving average value i obtained by moving average value computation circuit 22, and if the error between period measurement value h and moving average value i is within a prescribed range, it is determined that a frequency-lock has been established. The detection result signal obtained by frequency-lock detector 58 is sent as the same clock selection signal as clock selection signal k from phase-lock detector 38 through AND-gate (60Z) to clock selecting circuit 40. As a result, the lock judgment becomes more reliable, and the overall control more stable. Also, in this embodiment, in said hold mode, hold control part 52 also holds the operation of range counter 56. Also, in this case, control may be performed such that during the hold time, clock j is selected by clock selecting circuit 40.

The aforementioned embodiments are merely examples of the constitution of the various parts. Various modifications can be used within the range of the present invention. For example, the phase comparison and control signal output of phase comparators 10, 54 are merely an example. Any digital scheme may be used as well. Also, the constitution and operation of intermediate oscillating frequency divider 18, especially the operation of up/down counter 28 and pre-scaler 30, are merely examples, and various other frequency division technologies may be used. The same is true for frequency measurement circuit 20, moving average value computation circuit 22, output clock generator 24, frequency division ratio control part (range counter) 56, etc. They may be realized with any digital circuit. Also, in said Embodiment 2, one may also adopt the lock range improvement technology of the DPLL circuit without using a moving average. For example, in said embodiments, one may omit period measurement circuit 20, moving average value computation circuit 22 and output clock generator 24, and use a constitution of the device with clock g generated by frequency divider 18 as the DPLL output.

1. A digital phase-locked loop circuit that generates a locked output clock at a frequency M-times (where M is an integer of 2 or more) that of the input prescribed reference clock and comprises the following parts:
a first frequency divider that divides the frequency of said reference clock to 1/M to generate a feedback clock,
a first phase comparator that compares the phase of said reference clock and said feedback clock and generates a first synchronization control signal corresponding to the phase difference,
a second frequency divider that divides the first master clock to 1/N (where N is an integer of 2 or more) according to the first synchronization control signal obtained by said first phase comparator and generates an intermediate clock at a frequency M-times that of said reference clock,
a period measurement circuit that measures the period of each said intermediate clock generated by said second frequency divider,
a moving average value computation circuit that determines the moving average value of the period of said intermediate clock on the basis of the period measurement value obtained by said period measurement circuit,
and an output clock generator that generates a clock having a period corresponding to the moving average value of the intermediate clock obtained by said moving average value computation circuit as said output clock.

2. The digital phase-locked loop circuit described in claim 1 wherein said second frequency divider has a counter for frequency division that counts said first master clock at the counter operating frequency corresponding to the first synchronization control signal from said first phase comparator.

3. The digital phase-locked loop circuit described in claim 1 wherein said second frequency divider has a 1-bit counter that counts said first master clock at the counter operating frequency corresponding to the first synchronization control signal from said first phase comparator, and a pre-scaler that counts the clock output from said 1-bit counter and generates said intermediate clock.

4. The digital phase-locked loop circuit described in claim 3 wherein said 1-bit counter has the following count modes: a first count mode that counts one for every two clocks of said first master clock, a second count mode that counts three for every four clocks of said first master clock corresponding to the first synchronization control signal from said first phase comparator, which represents the phase delay of said feedback clock with respect to said reference clock, and a third count mode that counts one for every four clocks of said first master clock corresponding to the first synchronization control signal from said first phase comparator, which represents the phase advance of said feedback clock with respect to said reference clock.

5. The digital phase-locked loop circuit described in claim 1 wherein said first phase comparator uses the rising edge or falling edge of said reference clock as the first clock timing and uses the rising edge or falling edge of said feedback clock as the second clock timing to determine the lead/lag relationship between said first clock timing and said second clock timing, and outputs said first synchronization control signal during the period between said two leading/lagging clock timings.

6. The digital phase-locked loop circuit described in claim 1 wherein said period measurement circuit has a time-measuring counter that counts the second master clock.

7. The digital phase-locked loop circuit described in claim 1 wherein said moving average value computation circuit has a sampling part that extracts at a prescribed shift pitch A period measurement values of the A (where A is an integer of 2 or more) consecutive intermediate clock portions obtained by said period measurement circuit, and an average value computation circuit that determines the average value of said A period measurement values extracted by said sampling part.

8. The digital phase-locked loop circuit described in claim 1 wherein said output clock generator is an oscillation counter that counts the third master clock.

9. The digital phase-locked loop circuit described in claim 1 wherein it contains a feedback control part, to which is input said intermediate clock generated by said second frequency divider and said output clock generated by said clock generator, and which selects said intermediate clock or said output clock and sends it to said first frequency divider.

10. The digital phase-locked loop circuit described in claim 9 wherein said feedback control part has a phase-lock detector that detects whether the phase-locked state is established between said reference clock and said feedback clock, and said intermediate clock or said output clock is selected corresponding to the detection result of said phase-lock detector.

11. The digital phase-locked loop circuit described in claim 10 wherein said phase-lock detector comprises the following parts:
an edge detector that detects the rising edge or falling edge of said input clock as the first clock edge, and detects the rising edge or falling edge of said feedback clock as the second clock edge,
a consecutive alternating input cycles counter that counts the number of consecutive cycles with alternately input first clock edge and second clock edge,
and a control signal output circuit that outputs a control signal for selecting said intermediate clock from a prescribed initial state until the count value of said consecutive alternating input cycles counter exceeds a prescribed value, and a control signal for selecting said output clock after the count value of said consecutive alternating input cycles counter exceeds the prescribed value.

12. The digital phase-locked loop circuit described in claim 11 wherein it has a counter control unit that resets the count value of said consecutive alternating input cycles counter when alternating said first clock edge and said second clock edge inputs are not established.

13. The digital phase-locked loop circuit described in claim 9 wherein said feedback control part contains a frequency-lock detector that compares the period measurement value with said period measurement circuit and the moving average value obtained by said moving average value computation circuit to detect whether the frequency-locked state has been established, and said intermediate clock or said output clock is selected corresponding to the detection result of said frequency-lock detector.

14. The digital phase-locked loop circuit described in claim 1 wherein it contains a hold control part that suspends the computation processing of said moving average value computation circuit so as to temporarily hold the output clock generated by said output clock generator constant.

15. The digital phase-locked loop circuit described in claim 14 wherein said feedback control part selects said output clock during the period when said hold control part suspends the computation process of said moving average value computation circuit.

16. The digital phase-locked loop circuit described in claim 1 further comprising
a second phase comparator that compares the phase of said reference clock and said feedback clock and generates a second synchronization control signal,
and a frequency division ratio control part that controls and adjusts frequency division ratio N of said second frequency divider corresponding to the second synchronization control signal obtained by said second phase comparator.

17. The digital phase-locked loop circuit described in claim 16 wherein said second phase comparator detects the phase difference between said reference clock and said feedback clock at a sensitivity lower than that of said first phase comparator.

18. The digital phase-locked loop circuit described in claim 17 wherein said second phase comparator outputs said second synchronization control signal when the phase difference between said reference clock and said feedback clock falls outside a prescribed range.

19. The digital phase-locked loop circuit described in claim 16 wherein said frequency division ratio control part has a range counter that sets the reference frequency division ratio with respect to said second frequency divider as the initial count value, and adjusts the count value corresponding to the second synchronization control signal from said second phase comparator.

20. A digital phase-locked loop circuit for generating a locked output clock at a frequency M-times (where M is an integer of 2 or more) that of the input prescribed reference clock comprises the following parts:
a first frequency divider that divides the frequency of said output clock to 1/M to generate a feedback clock,
a first phase comparator that compares the phase of said input reference clock and said feedback clock and generates a first synchronization control signal corresponding to the phase difference,
a second frequency divider that divides the first master clock to 1/N (where N is an integer of 2 or more) according to the first synchronization control signal obtained by said first phase comparator and generates an output clock at a frequency M-times that of said reference clock,
a second phase comparator that compares the phase of said reference clock and said feedback clock to generate a second synchronization control signal corresponding to the phase difference,
and a frequency division ratio control part that controls and adjusts frequency division ratio N of said second frequency divider corresponding to the second synchronization control signal obtained by said second phase comparator.

21. The digital phase-locked loop circuit described in claim 20 wherein said second frequency divider has a counter for frequency division that counts said first master clock at the counter operating frequency corresponding to the first synchronization control signal from said first phase comparator.

22. The digital phase-locked loop circuit described in claim 20 wherein said second frequency divider has a 1-bit counter that counts said first master clock at the counter operating frequency corresponding to the first synchronization control signal from said first phase comparator, and a pre-scaler that counts the clock output from said 1-bit counter and generates said output clock.

23. The digital phase-locked loop circuit described in claim 22 wherein said 1-bit counter has the following count modes: a first count mode that counts one for every two clocks of said first master clock, a second count mode that counts three for every four clocks of said first master clock corresponding to the first synchronization control signal from said first phase comparator, which represents the phase delay of said feedback clock with respect to said reference clock, and a third count mode that counts one for every four clocks of said first master clock corresponding to the first synchronization control signal from said first phase comparator, which represents the phase advance of said feedback clock with respect to said reference clock.

24. The digital phase-locked loop circuit described in claim 20 wherein said first phase comparator takes the rising edge or falling edge of said reference clock as the first clock timing and uses the rising edge or falling edge of said feedback clock as the second clock timing to determine the lead/lag relationship between said first clock timing and said second clock timing, and outputs said first synchronization control signal during the period between said two leading/lagging clock timings.

25. The digital phase-locked loop circuit described in claim 20 wherein said second phase comparator detects the phase difference between said reference clock and said feedback clock at a sensitivity lower than that of said first phase comparator.

26. The digital phase-locked loop circuit described in claim 25 wherein said second phase comparator outputs said second synchronization control signal when the phase difference between said reference clock and said feedback clock becomes greater than a prescribed value.

27. The digital phase-locked loop circuit described in claim 20 wherein said frequency division ratio control part has a range counter that sets the reference frequency division ratio as the initial count value for said second frequency divider, and adjusts the count value corresponding to said second synchronization control signal from said second phase comparator.
